(19) United States
(12) Patent Application Publication
(10) Pub. No.: US 2017/0261188 A1
(43) Pub. Date: Sep. 14, 2017

(54) Illuminated Ring Adapter/ Converter

(71) Applicant: Kelli J. Brindle, Pittsburgh, PA (US)

(72) Inventor: Kelli J. Brindle, Pittsburgh, PA (US)

(21) Appl. No.: 15/450,080

(22) Filed: Mar. 6, 2017

Related U.S. Application Data
(60) Provisional application No. 62/305,594, filed on Mar. 9, 2016.

(51) Int. Cl. F21V 21/092; F21V 3/04; F21L 4/08; F21V 23/04; F21L 14/00

(52) U.S. Cl. CPC F21V 21/0925; F21V 23/0414; F21L 14/00; F21L 4/08; F21V 3/0445; F21Y 2115/10

(57) ABSTRACT

Disclosed is a portable illumination device that is used in conjunction with mirrors that are commonly situated in residences such as homes, apartments, motels, cabins, etc. The device allows a user to groom with sufficient lighting using virtually any household mirror that they currently have or any mirror that might be available when traveling.

### FIELD OF THE INVENTION

The present invention relates to a portable illumination device that is used in conjunction with mirrors that are commonly situated in residences such as homes, apartments, motels, cabins, etc. This non-provisional patent application claims the benefit of U.S. provisional patent application Ser. No. 62/305,594 filed on Mar. 9, 2016.

### BACKGROUND OF THE INVENTION

A mirror in a residence is typically used for grooming. However some grooming practices, such as applying makeup, require exceptional lighting to be done effectively. Many bathroom and bedroom mirrors are not located where acceptable lighting is available, and it is usually not practical to install such lighting. Increasing interest in the cosmetic market has resulted in the production of several varieties of the illuminated cosmetic mirror, including counter top and wall mounting methods. These devices are typically housed in a body or a form with a set mirror omitting a peripheral brim of light. Users find the over-all viewing surface and size of mirrors in some of these devices to be too small. To counteract this issue, larger counter-top model illumination devices have been developed. However, these current devices use valuable counter top space; many users have extremely limited counter top space. Several wall mounted illuminated mirrors do not utilize counter top space. However, in many of these devices, users must commit to a permanent installation and hardwiring. This is not an option for those who rent or who are traveling elsewhere and utilizing facilities that are not their own. The current devices also have other drawbacks. Their maximum light intensity is still not sufficient for grooming and the range of their usable viewing angles is uncomfortable for many users. What is needed is a portable illumination device that allows a user to groom with sufficient lighting using virtually any household mirror that they currently have or any mirror that might be available when traveling.

### BRIEF DESCRIPTIONS OF THE DRAWINGS

FIG. 1 is a perspective view of an embodiment of the portable illumination device.

FIG. 2 is an exploded view of an embodiment of the portable illumination device.

FIG. 3 shows an embodiment of the device in use.

FIG. 4 shows an embodiment of the device mounted in a stand.

FIG. 5 is a side view of an embodiment of the device highlighting a powering alternative.

FIG. 6 is a posterior view of an embodiment of the device highlighting the mounting mechanism.

### DESCRIPTION OF THE INVENTION

An illumination device that can be used with virtually any common residential mirror is described. The illumination device includes a directionally forward-facing panel of light emitting diodes arranged in an array lining the midpoint of the shape of the housing, underlying a curved diffusive surface. Some embodiments include a dimming mechanism to accommodate user preference of brightness variation. The device is easily attachable to and easily releasable from a mirror. This allows a user to illuminate virtually any mirror in their household or virtually any mirror encounter while traveling.

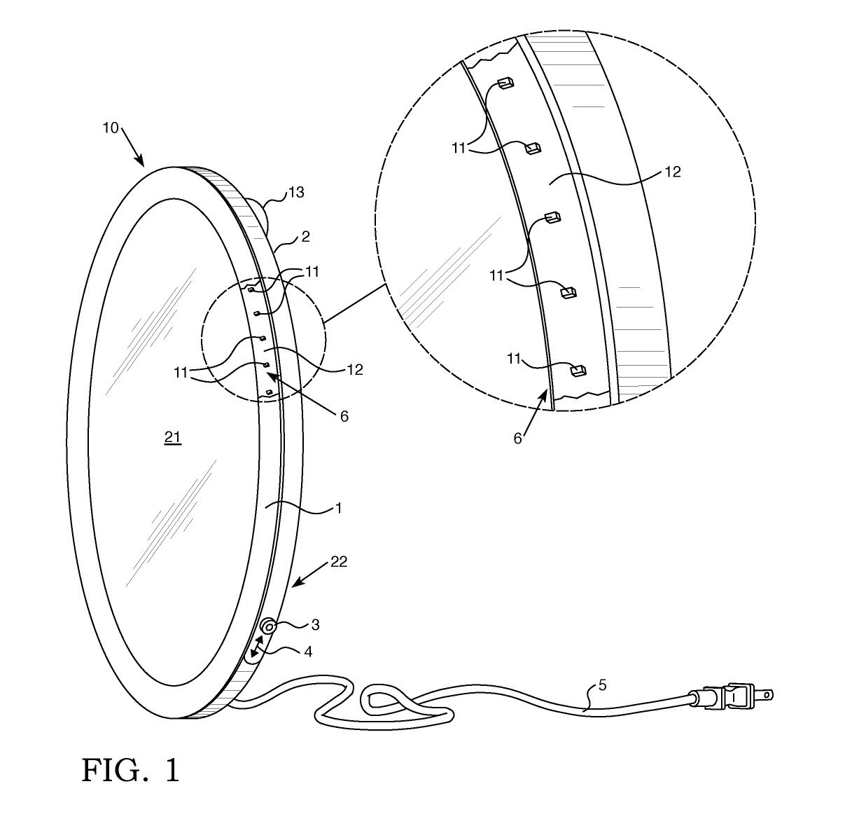

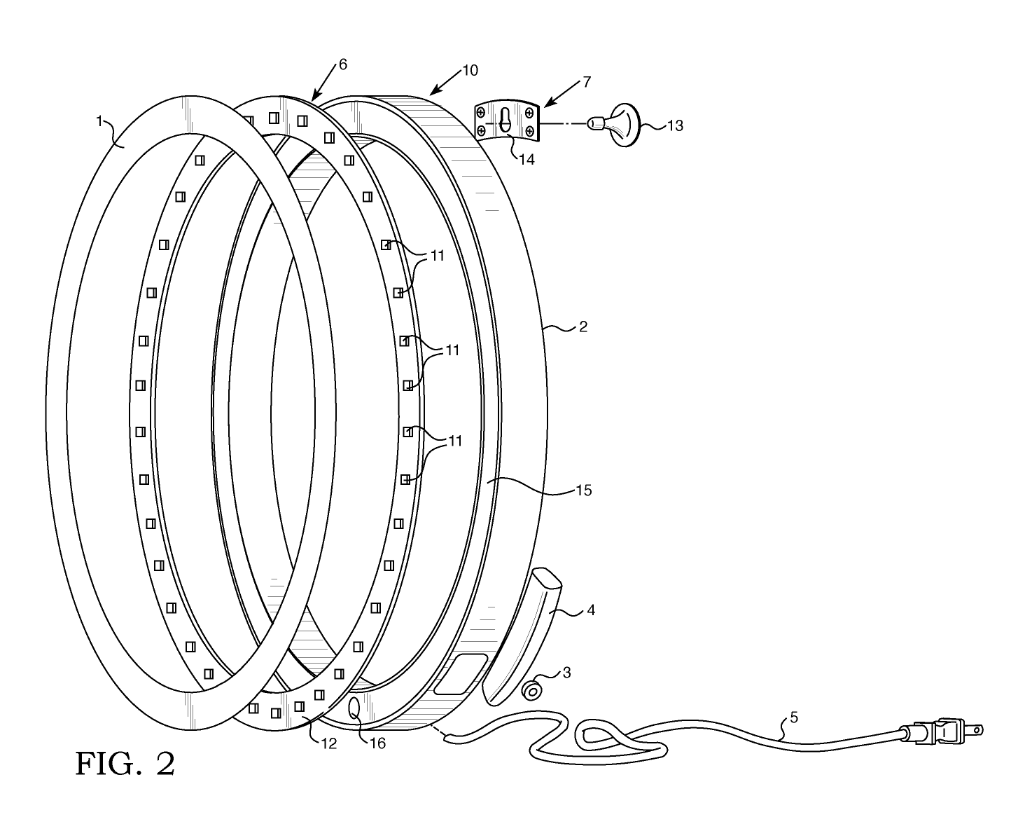

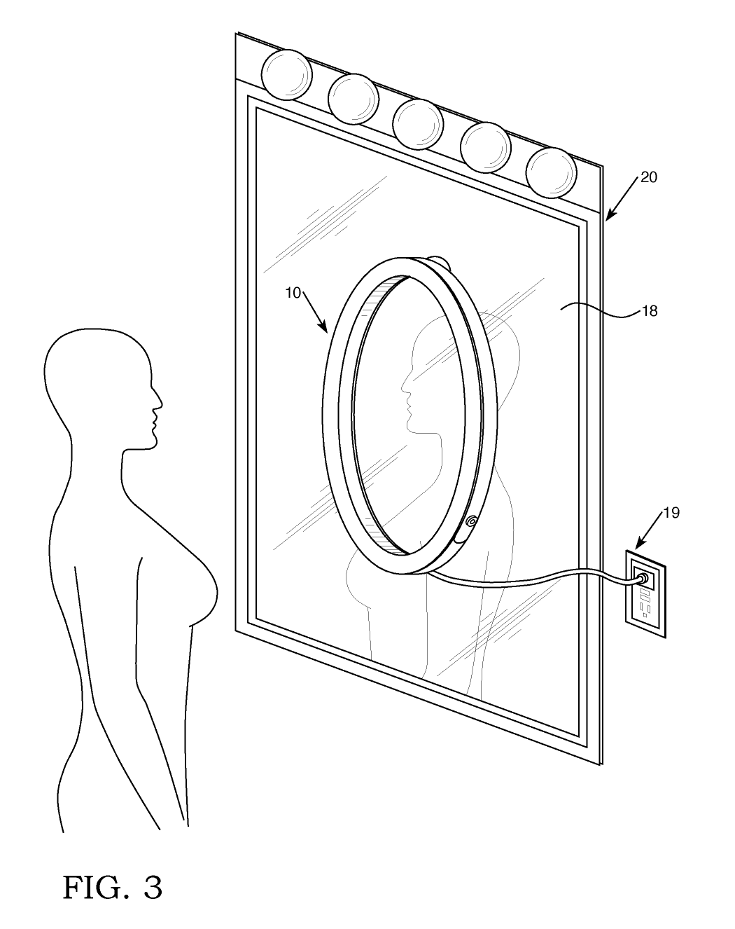

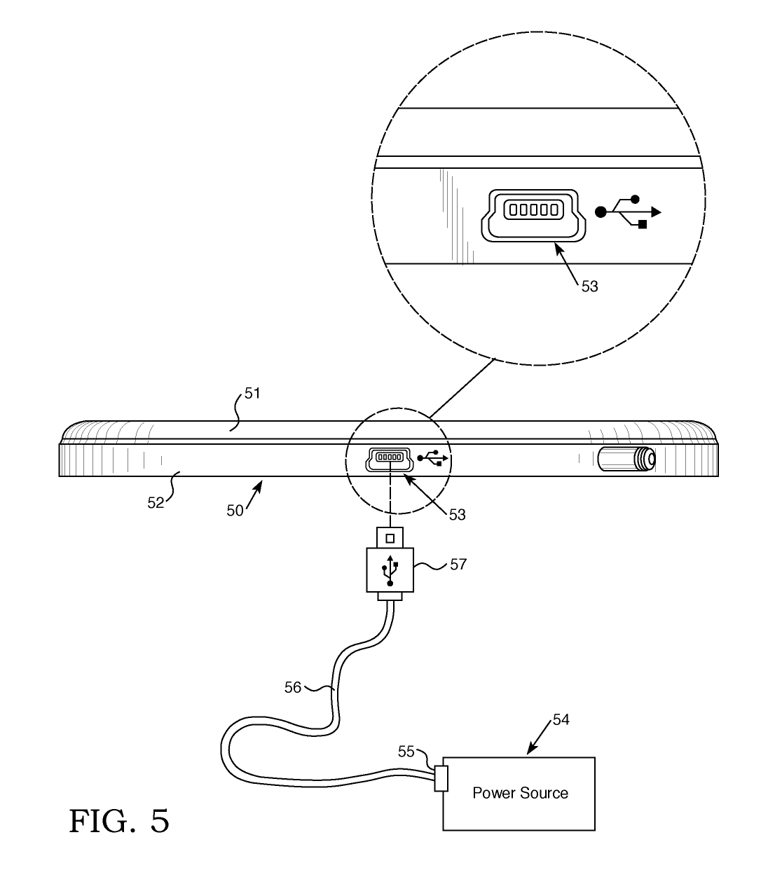

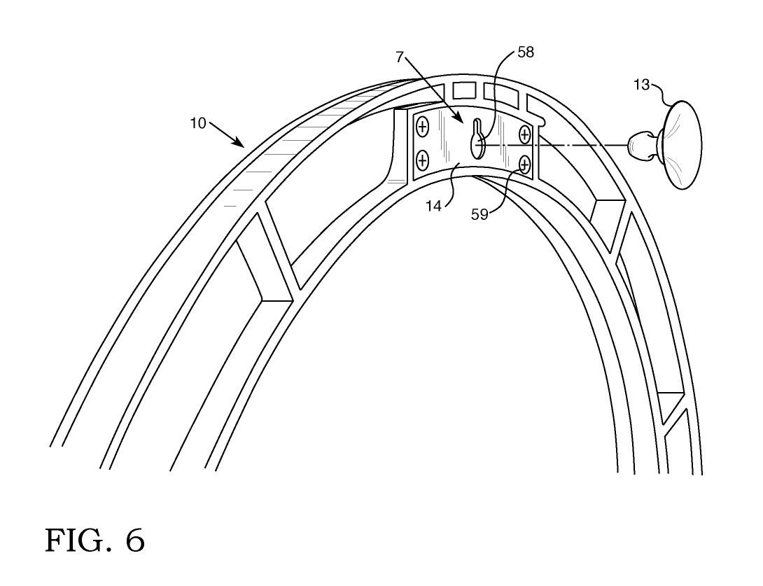

FIG. 1 is a perspective view of an embodiment of the portable illumination device and FIG. 2 is an exploded view an embodiment of the illumination device. Device 10 is comprised of a frame 22 which is illuminated on the anterior side and connected to a vertical surface such as a mirror on the posterior side. Housing 2, lighting element 6, and diffused surface 1 are joined together to comprise frame 22 enclosing opening 21 through which users will view themselves in a mirror when device 10 is mounted, as depicted in FIG. 3. Housing 2 secures lighting element 6 under diffused surface 1 which is located on the anterior side of frame 22. Lighting element 6 is comprised of a strip 12 inlayed with a plurality of light emitting diodes (LEDs) 11 facing the diffused surface 1. This is seen more clearly in FIG. 1, where a piece of diffused surface 1 is cut away and to show the interior of housing 2 for illustration purposes only. Diffused surface 1 is preferably fabricated in a semi-translucent, shatter resistant material such as high-density polyethylene or polyvinyl chloride. The color of light emitted from LEDs is preferably white, but any color light is contemplated by this disclosure. The anterior of housing 2 may contain a ridge 15 in which lighting element 6 is inset. Housing 2 is further comprised of power switch 3, dimmer slide 4, power cord 5, card hole 16, and mounting mechanism 7. Frame 22 can be variable in shape; however, the most preferred shape is an oval shape to best focus on the facial shape for grooming. Frame 22 can also be variable in size. Ideally the device is sized so that the opening 21 is large enough to frame a typical face when being viewed in mirror by a user, while the device 10 overall is compact enough to make it easier for a user to transport in for their luggage when traveling. Housing 2 can be fabricated of materials known in the art such as a rust-resistant metal and/or plastic. Preferably the material is strong enough to resist breakage, while being lightweight enough tor the device to be hung for long periods of time and for ease of portability of the device. Preferably, as seen closer in FIG. 6, mounting mechanism 7 located on the posterior of frame 22 is comprised of a suction cup 13 and bracket 14. Bracket 14 is secured to the posterior of frame 22 by fastening means 59, depicted here as screws but any typical fastening means known in the art is contemplated by the invention. The back of suction cup 13 is inserted into hole 58 in wide portion and slid up and locked into the narrow portion interlocking suction cup 13 with hole 58. Suction cup 13 allows for easy attachment and release from a surface. Though only one suction cup/hole combination is shown here located centrally in the bracket 14, this disclosure also contemplates a plurality of such combinations non-centrally located to be used as well. Other non-permanent mounting mechanisms are also contemplated by this disclosure. Dimmer slide 4, as can be seen better seen in FIG. 2 preferably allows power switch 3 to act as a sliding dimmer switch which in turn allows the user to adjust the light intensity to their preference in varying lighting situations. Other types of dimmer mechanisms, such as turning knobs or remote controlled dimmers, are also contemplated by this disclosure. As shown here in FIGS. 1 and 2 by power cord 5 the method of power is as standard cord of varying length able to be plugged into a common dual prong wall mounted outlet to power the unit. The energy is delivered from the power cord to the LEDs using standard methods known in the art. Any common power input apparatus that utilizes any common power source are contemplated by this disclosure. A non-limiting example of an alternative power source and power input is shown in FIG. 5 below a typical Universal Serial Bus (USB) cord can be used to recharge a compatible battery to power the illuminated device. Another non-limiting example can be typical alkaline batteries used in typical chamber with terminals; said chamber is part of the frame or connected to the frame as the power input.

How an embodiment of the device would typically be used is shown in FIG. 3. Device 10 is shown attached to a mirror 18 inside a mirror frame 20 as person could typically use the device 10. As shown here, device 10 is plugged into a typical wall mounted outlet 19.

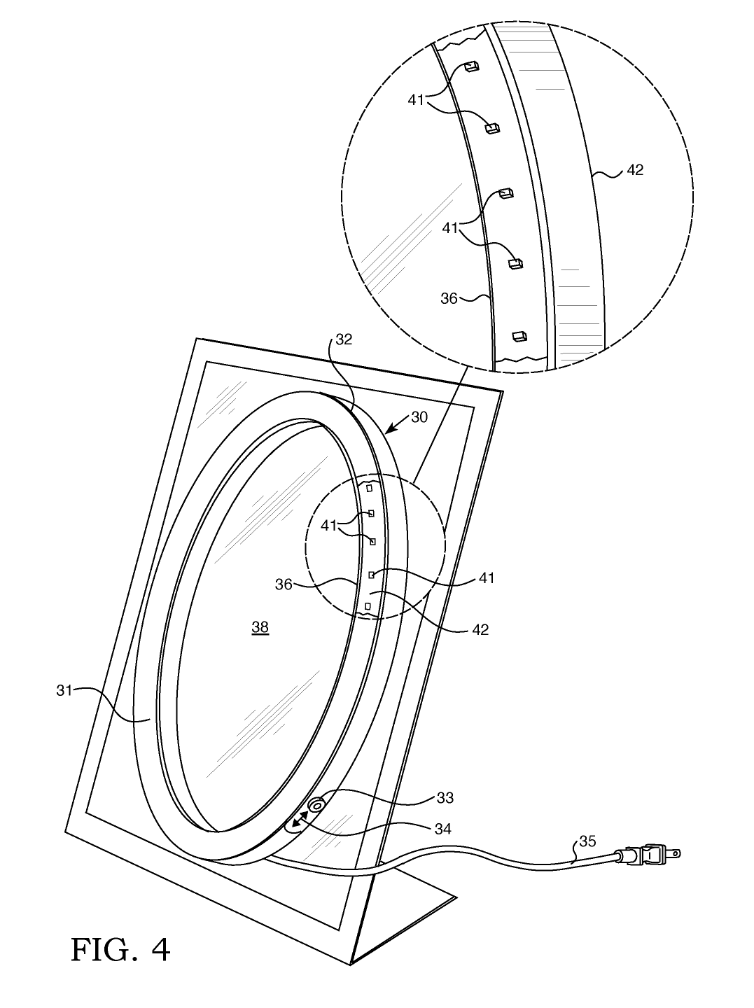

FIG. 4 shows an alternative embodiment of a stand mounted device. Device 30 is inset within stand 37 and outlines mirror 38. Device 30 is comprised of housing 32 which frames lighting element 36 under diffused surface 31. Lighting element 36 is comprised of a strip 42 inlayed with a plurality of light emitting diodes (LEDs) 41; shown here in the interior of housing 32 where a piece of diffused surface 31 is cut away for illustration purposes. Diffused surface 31 is preferably fabricated in a semi-translucent, shatter resistant material such as high-density polyethylene or polyvinyl chloride. Housing 32 is further comprised of power switch 43, dimmer slide 34, and power cord 35.

FIG. 5 illustrates a powering alternative for an embodiment of the device, which allows one or more batteries in the device to be charged and used while not being attached to power source. Device 50 is comprised of housing 52 and diffused surface 51. Housing 52 contains device receptacle 53. Device receptacle 53 can be designed to receive a typical device connector 57. For example, device connector 57 can be micro USB-B connector. Device connector 57 is attached at one end to cord 56, while attached at the opposite end of cord 56 is a typical power source connector 55. An option for power source connector 55 can be a USB-A connector. Cord 56 connects device 50 to a power source 54 which in turn charges one or more batteries within device 50. Power source 54 can be any power source known the art that connects and charges device batteries via typical cords such as the depicted cord 56. This embodiment allows the user to illuminate virtually any mirror that they encounter within their home or while traveling without worrying about having a convenient wall mounted outlet available.

The foregoing description merely illustrates the invention is not intended to be limiting. It will be apparent to those skilled in the art that various modifications can be made without departing from the inventive concept. Accordingly it is not intended that the invention be limited except by the appended claims.

1. An illuminated device comprised of:
A frame having an anterior side and a posterior side and enclosing an opening; the frame being comprised of a housing, a lighting element, and a diffused surface; said diffused surface located on the anterior side of the frame; wherein the lighting element is inset, within the housing and covered by the diffuse surface, and wherein the lighting element is comprised of a strip inlaid with a plurality of light emitting diodes (LEDs) facing the diffused surface of the frame; the frame further comprised of a power input apparatus that supplies energy to the LEDs illuminating the diffuse surface; and wherein a mounting mechanism is connected to the posterior side of the frame; said mounting mechanism being used for attaching the frame to a mirror.

2. The device of claim 1 wherein the frame is further comprised of a power switch.

3. The device of claim 1 wherein the frame is further comprised of a dimmer mechanism.

4. The device of claim 1 wherein the power input apparatus is a power cord.

5. The device of claim 1 wherein the power input apparatus is a receptacle designed to receive a micro USB-B connector.

6. The device of claim 1 wherein the power input apparatus is a battery chamber.

7. The device of claim 1 wherein the LEDs emit a white color.

8. The device of claim 1 wherein the diffused surface is semi-translucent.

9. The device of claim 1 wherein the diffused surface is comprised of a high-density polyethylene.

10. The device of claim 1 wherein the diffused surface is a comprised polyvinyl chloride.

11. The device of claim 1 wherein the frame is an oval shape.

12. The device of claim 1 wherein the housing is comprised of plastic.

13. The device of claim 1 wherein the housing is comprised of rust-resistant metal.

14. The device of claim 1 wherein the mounting mechanism is comprised of a bracket with a plurality of holes; the bracket secured to the posterior of the frame by fastening means; and each hole interlocking with a suction cup.

15. The device of claim 1 wherein the mounting mechanism is comprised of a bracket with a single hole centrally located interlocking with a suction cup and the bracket secured to the posterior of the frame by a fastening means.

16. A method of illuminating a mirror on vertical surface for a user grooming themselves comprising the steps of:
a) providing the mirror attached to the vertical surface;
b) attaching an illumination device to the mirror; the illuminating device comprised of a frame having an anterior side and a posterior side and enclosing an opening; the frame being comprised of a housing, a lighting element, and a diffused surface; said diffused surface located on the anterior side of the frame; wherein the lighting element is inset within the housing and covered by the diffuse surface, and wherein the lighting element is comprised of a strip inlaid with a plurality of light emitting diodes (LEDs) facing the diffused surface of the frame; the frame further comprised of a power input apparatus that supplies energy to the LEDs illuminating the diffuse surface; and wherein a mounting mechanism is connected to the posterior side of the frame; said mounting mechanism being used for attaching the frame to the mirror; and
c) supplying said energy to LEDs via the power input apparatus.

17. The method of claim 16 wherein the mounting mechanism is comprised of a bracket with a plurality of holes; the bracket secured to the posterior of the frame by a fastening means; and each hole interlocking with a suction cup.

18. The method of claim 16 wherein the mounting mechanism is comprised of a bracket with a single hole centrally located interlocking with a suction cup and the bracket secured to the posterior of the frame by a fastening means.

19. The method of claim 16 wherein the LEDs emit a white color light illuminating the mirror on the vertical surface.
